(19) United States
(12) Patent Application Publication
(10) Pub. No.: US 2024/0051332 A1
(43) Pub. Date: Feb. 15, 2024

(54) MEDIA WITH WHITE ABSORBING LAYER USED TO REVEAL IMAGES

(71) Applicant: ROBERT J. MABBOTT, BRADENTON, FL (US)

(72) Inventor: ROBERT J. MABBOTT, BRADENTON, FL (US)

(21) Appl. No.: 18/230,735

(22) Filed: Aug. 7, 2023

Related U.S. Application Data
(60) Provisional application No. 63/396,837, filed on Aug. 10, 2022.

(51) Int. Cl. B44F 1/10; G09F 3/10; G09F 3/02

(52) U.S. Cl. CPC B44F 1/10; G09F 3/10; G09F 3/02; G09F 2003/021; G09F 2003/0257

(57) ABSTRACT

A media having a white opaque microporous coating, coated onto a releasable carrier, thereafter, being transposed and heat laminated to a clear material surface (30) as a non-transferable white opaque absorbing layer (20) over hidden visual elements (34), which when liquid (24) is applied, are gradually revealed until they are clearly visible.

### CROSS REFERENCE TO RELATED APPLICATION

This application claims the benefit of priority to provisional patent application 63/396,837 filed Aug. 10, 2022.

### FIELD OF THE INVENTION

The present invention relates to artistic media, more particularly to a media having a white opaque absorbing layer, which when brushed over with a liquid gradually reveals visual elements, hidden under the surface until they are clearly visible.

### BACKGROUND

Novel ways of making and presenting art have been around for centuries, so too has the ability to paint and draw on both sides of a translucent media. In fact, in the early 18^{th} Century artists created miniature portraits on sheets of ivory with watercolors. As the technique developed, the ivory sheets became so thin that they were almost transparent. To make use of this novel method artists would sometimes apply a silver foil on the back of the portrait to reflect light and give the sitter an almost glowing appearance.

Double sided drawing (Verso Artistry) was a technique developed by Jean Etienne Liotard, a renowned portrait artist of the 18^{th} Century, who would draw on one side of a very thin paper, then turn it over, hold it against a light source and then trace the design onto the other side. In this way he was able to draw a heightened solid color variation on the verso side of the paper, which in turn when the design was viewed from the front showed subtle variations and allowed the light palette, and the vivacity and freshness of the entire composition to show through. This was the first time that a piece of art could be viewed through a media, but it was not the first time that artists had painted on both sides of a media, which practice dates back to the time of Leonardo Da Vinci, who either deliberately allowed viewers to see a different painting on each side of his canvas, or like many artists of his time, was just short on funds and didn't have the money to buy material. Either way it was the first recorded double-sided painting on a media. Since then, hiding one painting behind another has become more of a feature than a necessity.

The ability to hide a painting from view and the reason for doing it has long since been a topic of both conversation and debate. An example of this is a genre painting created by the Dutch artist Johannes Vermeer in 1657. Girl Reading a Letter in an Open Window. The girl depicted in Vermeer's painting was believed to be standing in front of a plain, old, undecorated wall. However, X-rays revealed that this wall was actually a secondary coat of paint applied to obscure a picture of Cupid, the god of love. The reason the picture was hidden is unclear, however the concept behind the action of revealing art that was previously hidden from view creates an interesting phenomenon and to some, an interesting commercial endeavor. The definition of “Revealing” is to allow something to be seen that, until then, had been previously hidden.

One such endeavor that has great applicability to the idealism of the present invention, is that of the water reveal, which is described in different ways in numerous existing patents, all of which use water, colorless dyes or other liquids containing water to reveal graphic elements embedded in an absorbent or otherwise reactant layer. Idealism and relevance are two entirely different things, and it is the relevance of US 20210146671 A1 ‘Method to Emulate and Oil Painting’ that has is provided both the foundation and the ultimate building blocks for the present invention. US 20210146671 A1 describes a method that relates to digitally (mirror) printing an image on to an absorbing layer affixed to a releasable film carrier. The image is then transposed and permanently bonded to a surface suitable for painting on, before being revealed using oil absorption; brought about by the action of loading a paint brush with oil and brushing over the transposed image surface until all the underlying image is clearly visible.

Although the above description delivers much in the form of relevance to the present invention, there are some fundamental differences between the two, which for the sake of clarity can be recognized as the following: US 20210146671 in all embodiments uses a single sided print media which is mirror printed on an inkjet printer and then transferred to an adhesive coated surface, which surface may or may not be textured, but none the less, is applied to the surface under conditions of pressure and/or heat. While the methods and practices of US 20210146671 are particularly suitable for emulating an oil painting, it is cost prohibitive for most other creative markets and commercial endeavors, and does not encompass the depth, breadth and simplicity of the present invention in relation to providing the multiple benefits that can be derived from brushing over a white opaque absorbing layer with a liquid that gradually reveals visual elements, hidden under the surface until they are clearly visible

### SUMMARY OF THE INVENTION

The present invention not only provides a process whereby anyone of anyone with or without skill, can create an oil painting using digital printing and artistic endeavor, but additionally, they can mix and match the value proposition, associated with creating original art, thereby making it applicable to all forms of visual art, including digital art, photography, drawing and painting. There has been outlined a broad description of the art based on the ability to brush over a white opaque absorbing layer with a liquid that gradually reveals visual elements, hidden under the surface until they are clearly visible.

In order to truly appreciate the present contribution to the art, there are additional features of the present invention that will be described hereinafter that will form the subject matter to the claims appended hereto. In this respect, before explaining at least one embodiment of the present invention, it should be readily understood that brushing over a white opaque absorbing layer with a liquid that gradually reveals visual elements, hidden under the surface until they are clearly visible, as set forth in the following descriptions or drawings, is not limited by the details of application, therefore it should be clear that the phraseology and terminology employed herein is for descriptive purposes only and should not be regarded in anyway as limiting.

A preferred embodiment of the present invention provides for the detailing of the preparatory steps needed to enable the application of a non-transferable white opaque absorbing layer to be applied to different types of clear coated media over visual elements, or onto different clear film media, which film may be optically clear with a gloss finish or a clear matt finish, used as an intermediate film enabling many different types of visual elements to be seen after the absorbing layer has been revealed.

Accordingly, the steps are as follows:
1. a white microporous liquid material is coated on a commercial coating machine, capable of coating roll to roll which may be designed for aqueous coating; material is coated onto a releasable carrier which may be constructed of paper or film or a combination of both; material is coated using different coating methods, for example; Meyer bar, a liquid coating which is dried and rewound onto a core to make rolls; rolls are slit at different lengths and widths.
2. a roll is placed on an apparatus design for heat roll lamination, laminator is heated to a temperature of between 300-500° F. (152-260° C.); material coating is removed from the releasable carrier and transposed, so the absorbing layer is facing out; absorbing layer is transferred, using heat and pressure to a clear coating over visual elements or a clear intermediate film, which may or may not have an adhesive backing.

An embodiment of the present invention provides for the application of a non-transferable white opaque absorbing layer to different types a media, under conditions of heat and pressure, which may be onto a clear coated media, coated over visual elements, which elements may comprise photos, prints, text, drawings, graphics, or other individual element or combination thereof, or maybe heat and pressure laminated as an intermediate film enabling many different types of visual elements to be seen after the absorbing layer has been revealed.

An object of the present invention is to provide for the application of a non-transferable white opaque absorbing layer to a media, thereafter, applying a liquid, which application may be that of a brush of the type conventionally used to paint pictures or a fillable brush like that of a water pen, or any other type of implement capable of applying a liquid to an absorbable surface.

In another embodiment, the present invention provides for application of a non-transferable white opaque absorbing layer to a clear film media placing said film clear face down onto a material surface containing visual elements, which elements may comprise pictures, drawings, graphics, text, photos and any combination thereof, thereafter, obscuring the image, applying a liquid to the said layer which gradually reveals the underlying hidden surface until each of the visual elements are clearly visible, thereafter wiping any excess liquid from the surface and waiting for it to dry naturally.

In another embodiment, the present invention provides for a clear film media, to be coated on one side with an optically clear adhesive, with a white opaque, non-transferable absorbing layer applied to the other, which remains unprinted, applying said film clear adhesive face down onto a material surface, which surface may be smoothed down to avoid air entrapment over visual elements which may comprise; pictures, drawings, graphics, text, photos and any combination thereof, thereafter, obscuring the image, applying a liquid to the said white opaque absorbing layer which gradually reveals the underlying hidden surface until each of the visual elements are clearly visible, thereafter, wiping any excess liquid from the surface, or alternatively, waiting for it to dry naturally.

An object of the present invention is to provide for the application of a non-transferable white opaque absorbing layer to one side of a clear film media wherein an adhesive element is applied to the other side and that the adhesive element may comprise a pressure sensitive adhesive, or heat activated adhesive which in the context of this specification, refers to a pressure sensitive adhesive as in commonly used terminology to a substance that is permanently sticky and tacky, especially at room temperature. Pressure sensitive adhesive (PSA) is characterized in that it can be applied to a substrate by pressure and adheres thereto; alternatively, the adhesive may be that of a heat activated adhesive which in the context of this specification refers to the heat activation of an adhesive as in commonly used terminology to a substance that melts and becomes tacky under conditions of heat and pressure. Heat activated adhesive (HAA) is characterized in that it can be applied to a substrate by heat and pressure and adheres thereto;

Another object of the present invention is to provide for the application of a non-transferable white opaque absorbing layer to one side of a clear film media wherein an adhesive element is applied to the other side, which element is protected until use by a releasable carrier, which may be constructed of film or paper, with release characteristics made consistent with the ability to cleanly remove the releasable carrier from the adhesive surface, providing what can be accurately described as an adhesive sticker that is characterized by the type of surface that it has been designed to adhere to, thereby making the reveal either peel-able and removable or permanent, each dependent on the target surface it is being applied to.

In an embodiment, the present invention provides for the (mirror) printing of one side of an ink receptive, optically clear film media, with a white opaque, non-transferable absorbing layer applied to the other, which remains unprinted, placing said film print face down onto a solid material surface, which surface may be adhesive and may comprise visual elements; solid color effects, textures, foil effects, glow in the dark and or other special effects, thereafter, obscuring the image, applying liquid to the said layer which gradually reveals the underlying hidden surface until it is clearly visible, thereafter wiping any excess liquid from the surface and waiting for it to dry naturally.

In another embodiment, the present invention provides for a clear film media, which may or may not be printed on the clear side, with a white opaque, non-transferable absorbing layer applied to the other, thereafter, obscuring the image, applying a liquid to the said layer which gradually reveals the underlying surface, thereafter wiping any excess liquid from the surface, then scraping off the absorbing layer completely from the film, with a device designed for scraping, which device may be made from plastic, so as not to scratch the film, thereafter, leaving it with a high scratch and mar resistant surface finish.

In another embodiment the present invention provides for a white opaque, non-transferable absorbing layer applied directly to a textured surface or media containing visual elements, which elements may be the result of digital printing, photography or artistic endeavor, which surface may be print receptive, which white opaque, non-transferable absorbing layer may be applied using a combination of heat and/or pressure, the sufficiency of which causes the original texture to remain. In another embodiment the present invention provides for a white opaque absorbing layer applied directly to a surface which surface may comprise a paper or a film, placing a removable graphic element, which may be a drawing, a design, a sketch, a print or a combination thereof, under the surface. Thereafter revealing the graphic element in a temporary fashion using a liquid, which liquid may be water or a blend of oil and water thereof, which shows the underlying hidden surface long enough to copy the graphic element using different types of marking tools, before it becomes hidden from view once again and the markings remain. Marking tools of the type described are those that are used to draw and paint and may include pencils, pens, brushes, or any other type of marking tool that may be deemed appropriate for the purpose, which may be used in the reveal process to produce both temporary and permanent effects. Removable graphic elements are those that can be inserted and removed from behind the surface bearing opaque absorbing layer.

In yet another embodiment the present invention provides for a white opaque absorbing layer to be applied to a 3D surface, which application may be by that of vacuum, heat assisted vacuum, forced heated air, or a combination thereof. To a surface that may comprise graphic elements applied to a solid form that may be of a rigid or flexible construction.

An object of the present invention is to provide for the application of a non-transferable white opaque absorbing layer to be applied to a 3D surface, a surface that may for example be that of a dolls face, an action figure face, or more specifically may be the face of a Barbie doll. Another object of the present invention is to provide a non-transferable white opaque absorbing layer, that is revealed using artistic endeavor, which may take the form of applying a liquid to the face model containing the non-transferable white opaque absorbing layer, which may be in the form of applying makeup, to reveal the underlying hidden face of a doll.

As can be seen from the above-described embodiments of the present invention, characteristically there is one constant that is mandatory for the present invention to work. The simplicity of which is as follows; applying a non-transferable white opaque absorbing layer to a surface that when liquid is applied, gradually reveals the underlying hidden surface until it is clearly visible.

### BRIEF DESCRIPTION OF THE DRAWINGS

In the following detailed description, reference will be made to the attached drawings in which:

FIG. 1 is a cross section of the preferred embodiment, showing apparatus designed to facilitate the removal, transposing and rewinding of a white opaque microporous coating, in readiness to be heat and pressure laminated to different types of clear coated, or optically clear media;

FIG. 2 is a cross section, showing a white opaque non-transferable absorbing layer, directly applied to a clear coated surface containing visual elements, applying a liquid to the surface, which thereafter gradually reveals the underlying hidden surface until it is clearly visible;

FIG. 3 is a cross section the same as FIG. 2 using an optically clear film with a white opaque non-transferable absorbing layer, applied, in place of the direct application of the same, making it independent of the surface containing visual elements;

FIG. 4 is a cross section the same as FIG. 3 bonded to a surface with a layer of adhesive affixed to the underside of an optically clear film, thereafter, bonded to a solid surface containing visual elements;

FIG. 5 is a cross section the same as FIG. 3 with visual elements printed on the underside of an optically clear film, with an ink, thereafter, being bonded to an adhesive bearing solid surface;

FIG. 6 is a cross section the same as FIG. 3 which is enabled on the absorbing layer to be printed with an inkjet printer;

FIG. 7 is a cross section the same as FIG. 3 with visual elements affixed to the absorbing layer, which surface can be enhanced using marking materials;

FIG. 8 is a cross section the same as FIG. 3 printed on the reverse side of the absorbing layer with an ink, which surface can be enhanced using marking materials;

FIG. 9 is a cross section the same as FIG. 3 which after revealing and drying the absorption layer is scraped off using a scraping tool;

FIG. 10 is a cross section the same as FIG. 3 which after revealing and drying the absorption layer is completely peeled off of the film;

FIG. 11 is a cross section the same as FIG. 2 wherein the solid material surface is a printed texture that remains after the absorbing layer has been revealed;

FIG. 12 is a cross section showing a white absorbing layer applied to a paper layer, with a removable/replaceable surface containing a graphic element placed below it, which surface is revealed temporarily using water, enabling the absorbing layer to be permanently marking using a marking tool; and

FIG. 13 is a cross section showing a printed face model affixed to a solid 3D material surface with an absorbing layer applied, enabling the face to be revealed using a liquid.

### DESCRIPTION OF THE EMBODIMENTS

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprise” and/or “comprising,” when used in this specification, specify the presence of stated features, steps, operations, elements, and/or components, but do not preclude the presence or addition of one or more other features, steps, operations, elements, components, and/or groups thereof. Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. Accordingly, for the sake of clarity, this description will refrain from repeating every possible workable combination in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one with ordinary skill in the art that the present invention may be practiced without these specific details. The present disclosure is to be considered as an exemplification of the invention and is not intended to limit the invention to the specific embodiments illustrated by the figures or to the detailed description herein. For the purpose of describing the embodiments hereto, the terminology used in reference to the drawings is as follows:
12—Transposed Coating
14—Release Film Rewind
16—Material Unwind
18—Coating Rewind
20—Absorbing Layer
22—Clear Film
24—Liquid
26—Ink Layer
28—Adhesion Promotion Layer
30—Solid Material Surface
32—Adhesive Layer
34—Visual Elements
36—Scraping Tool
38—Marking Materials
40—Texture
42—Oil and Water
44—Paper Layer
46—Removable Graphic Element
48—Marking Tool
50—Printed Face Model
52—Solid 3D Material Surface
54—Peelable Absorbing Layer

FIG. 1 is a cross section of the preferred embodiment, showing apparatus designed to facilitate the removal, transposing and rewinding of a white opaque microporous coating 12, in readiness to be heat and pressure laminated to different types of clear coated, or clear film media. It is a requirement for the absorbing layer 20 to be white opaque and microporous, most suited to be printed with multiple inkjet technologies with a dry thickness of 75-85 microns and an opacity up to and including 100%. It is a feature of the microporous coating 12 that it is applied to a surface in its dry state, and that the application of such coating should be able to be affected to the sealable side of the coating using heat and pressure, like that of a roll laminator. Although this applies to most if not all white microporous coatings, a preferred coating may be comprised of an Amorphous Silica 35-38% by weight, one such suitable coating is a matte inkjet receptive microporous formulation, which product name is PrintRite DP339 a product that is commercially available from the Lubrizol Corporation. The important factor being the porosity, which is linked directly to the requirement of the absorption values required to augment the reveal process when using different liquids, designed to yield the required result.

FIG. 2 is a cross section showing a white opaque, non-transferable absorbing layer 20 applied to a surface containing visual elements. Such layer 20 is required to be non-transferable once it has been applied to any media as an absorbing layer 20. In this preferred embodiment the surface the white opaque, non-transferable absorbing layer 20 is applied to is a surface containing visual elements 34 which may be comprised of any combination of the following; Line, Shape, Tone, Color, Pattern, Texture and Form, which are reflected in all forms of generated art. The material that carries the visual elements 34 is applicable to the transportation of art. Visual elements 34 can be situated on top or below the material that carries them, an example of such would be clear coatings, or clear films. It is a requirement for any element to be able to be revealed as clearly visible. The absorbing layer 20 has been designed to enable different types of liquid 24 to affect the reveal process. A liquid 24 is a type of matter with specific properties that make it less rigid than a solid but more rigid than a gas. A liquid 24 can flow and does not have a specific shape like a solid. There are different types of liquid 24 that can be used to reveal visual elements 34 for example sustainable oils like olive oil, coconut oil, avocado oil, sunflower oil, canola oil and palm oil, there are also oils that are used to create art as in paintings, like linseed oil that are not sustainable. There are different types of liquid 24 materials other than oils that can be used in the process of reveal, which include permanent reveals using resins, and temporary reveals using water. In all cases the liquid 24 that is used is either absorbed into the surface, naturally, or forced to penetrate the white opaque absorbing layer 20 using a type of brushing motion, as is the case with liquids made from water and oil.

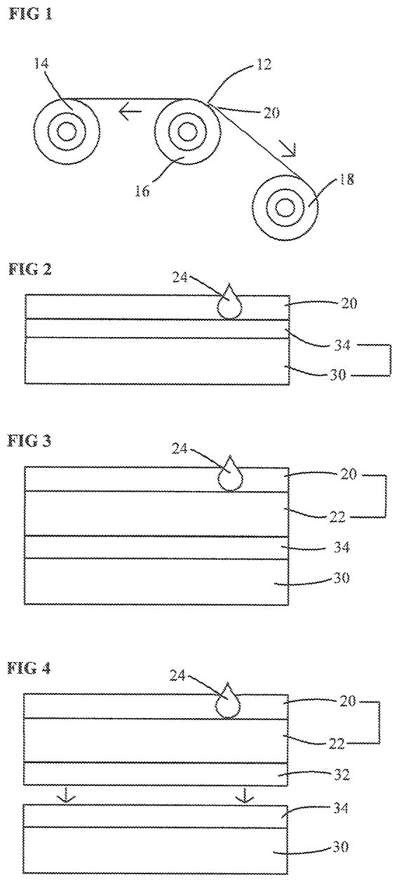

FIG. 3 is a cross section showing a clear or optically clear film media 22 secured between the absorbing layer 20 and visual elements 34. The reference to “optically clear” means a clear film that may be applied to glass without compromising light transmission or clarity, which before printing remains completely transparent, which after printing may be transparent, translucent or even completely opaque. There are several different types of clear films 22 to choose from, which range includes, but is not limited to, Polyester (PET), Polycarbonate, Polypropylene (PP) and Polyvinyl chloride (PVC), which may or may not have an adhesive backing, all of which may be chosen to facilitate one or more of the embodiments, herein described. In reference to the drawings Polyester is most relevant when it comes to printing, as it is commonly used in different types of printers, ranging from desktop inkjet to offset presses. Polyester is made in different material thicknesses, which for clear film 22 designed to be applied to a surface or printed may be in the range of 100-125 microns.

FIG. 4 is a cross section the same as FIG. 2 incorporating an adhesive layer 32 in the place of a ink layer 26 an adhesive layer 32 that may be coated or laminated to the clear side of the film 22 which adhesive layer 32 may comprise a pressure activated material of the type used in the construction of a home use label, or may be heat activated to enable high speed production, of which the requirements for both is for the adhesive layer 32 to be optically clear, so that when the absorbing layer 20 is brushed over with a liquid 24 the clarity of which remains and the underlying surface is revealed until it is clearly visible. The adhesive layer 32 may be applied to a surface containing visual elements 34 which may be attached to a solid material surface 30 which may be used as an intermediate material for the visual elements 34 these are static elements that form the underlying surface in its entirety, which may comprise pictures, drawings, graphics, text, photos and any other combination thereof.

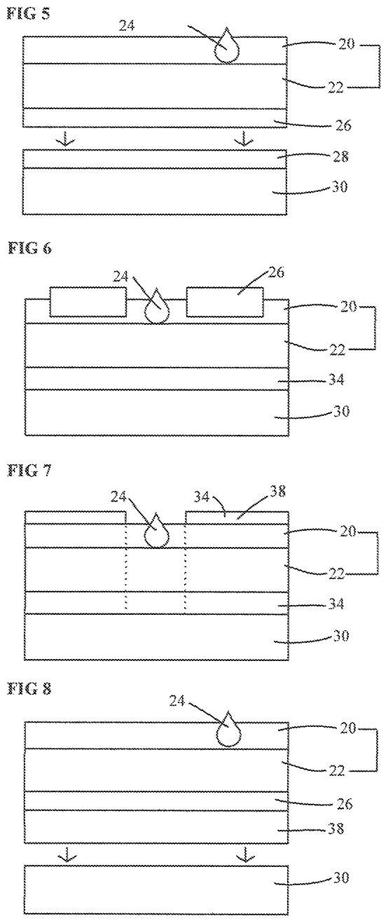

FIG. 5 is a cross section the same as FIG. 2 with the addition of an ink layer 26 which layer is applied as a clear coating onto which an image is printed with an ink which may be derived from a digital inkjet printer, which may use water based inks, to enable printing through home desktop printers, which may use UV based inks, to enable the printing of texture and metallics, which may use eco-solvent based inks, to enable higher speed and media compatibility, which may use latex inks, to enable faster drying times which may also use toner based powder to enable the selective use of metallic foils, or which may use conventional inks using offset, flexographic or letterpress printing technologies, before being applied to a solid material surface 30 using an adhesion promotion layer 28 which is first applied to the solid material surface 30 which adhesion promotion layer 28 may be that of an optically clear adhesive and which solid material surface 30 may be made from different types of plastics, cards and papers, which surfaces may be flat or contain textures to create illusion, which surfaces may also contain foil effects, which may include, holographic, metalized, glow in the dark or other such special effects, or may just remain transparent to enable light to be projected through it.

FIG. 6 is a cross section the same as FIG. 4, which may be with or without the adhesive layer 32, but with the printing of the absorbing layer 20 with an inkjet print 40 which may be delivered to and absorbed into the absorbing layer 20 by the use of a desktop inkjet printer, which inkjet print 40 is designed with both clear and printed areas, thereafter, being able to create new effects by blocking the reveal selectively to the underlying surface.

FIG. 7 is a cross section the same as FIG. 6, but without the inkjet print, in its stead the addition of visual elements 34 of the type described and or marking materials 38 used to create art. The marking materials may be with paint, more specifically, paints designed to paint onto art surfaces may be with ink, more specifically, inks as used in a felt tip or paint pen, which may be with a pencil, more specifically soft pencils used to sketch, which may be with cutout shapes, more specifically shapes, both positive and negative, which may include paper, card and plastic, or any other material that can be affixed to the absorbing layer 20 designed to make selective areas of the underlying surface clearly visible.

FIG. 8 is a cross section the same as FIG. 3, but without the adhesion promotion layer 28 In its stead, marking materials 38 which may be applied in different forms to the ink layer 26 after printing, thereafter, being applied to the solid material surface 30 before being brushed over with a liquid 24 and gradually revealing the underlying surface until it is clearly visible.

FIG. 9 is a cross section the same as FIG. 3 which action is an option that can only be exercised after the absorbing layer 20 has been revealed with liquid 24 and the underlying hidden surface is clearly visible and is dry to the touch. The action, which may comprise wiping liquid 24 excess from the surface, then scraping off the absorbing layer 20 with a scraping tool 36 which device may be made from plastic, so as not to scratch the surface, thereafter, leaving it with a high gloss or matt, scratch and mar resistant finish, is an action that enables the original underlying visual elements to be revealed unencumbered by any intermediate layer. This is particularly important when the visual elements are those that are light activated, like solid foils that are metallic or diffraction or transparent foils embedded with holograms, or they may also be glow in the dark activated by UV light. The result of removing the absorbing layer 20 after the reveal, is also significant to the fact that it promotes longevity of the underlying visual elements, for example, preserving a photograph on paper, an artistic visual, which may be a sketch, or a painting, or even creating visual elements 34 with archival properties.

FIG. 10 is a cross section the same as FIG. 3—which action is an option that can only be exercised after the absorbing layer 20 has been revealed with liquid 24 and the underlying hidden surface is clearly visible and is dry to the touch. The action, which may comprise wiping liquid 24 excess from the surface waiting for it to dry naturally, then completely peeling off the peelable absorbing layer 54 thereafter, leaving it with a matt or high gloss, scratch and mar resistant finish, is an action that enables the original underlying visual elements to be revealed unencumbered by any intermediate layer. This is particularly important when the visual elements are those that are light activated, like solid foils that are metallic or diffraction or transparent foils embedded with holograms, or they may also be glow in the dark activated by UV light. The result of removing the absorbing layer 54 after the reveal, is also significant to the fact that it promotes longevity of the underlying visual elements, for example, preserving a photograph on paper, an artistic visual, which may be a sketch, or a painting, or even creating visual elements 34 with archival properties.

FIG. 11 is a cross section the same as FIG. 2, but with a texture 40 affixed or integrated into the solid material surface 30 which may be a canvas designed for digitally printing, which may comprise visual elements 34 printed on an inkjet printer, like that of an aqueous printer, an eco-solvent printer, a solvent printer or a UV printer, which may be capable of printing texture 40 or maybe a 3D printer also capable of printing texture 40 if the texture is not already integrated into the solid material surface 30 applying the absorbing layer 20 which layer may be applied using pressure, which pressure may be applied using a roller, or pressed in using a flat plate, which pressure may also be from using vacuum or heat assisted vacuum, all used to reflect the underlying texture 40, which texture 40 may be canvas, or maybe digitally printed using texture inks from a UV printer or maybe generated from 3D CAD files, using a 3D printer, thereafter, being revealed using liquid 24, which may be an oil applied using a brush which may be that of an artist's brush, brushed into the texture of the absorbing layer 20 in order to gradually reveal the underlying hidden surface until it is clearly visible.

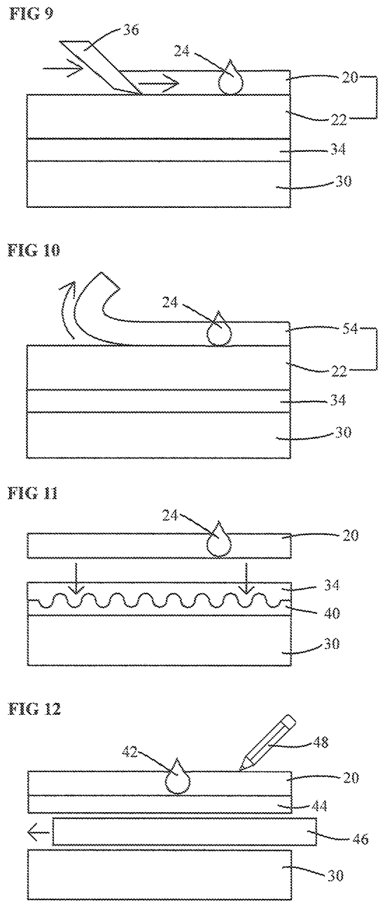

FIG. 12 is a cross section the same as FIG. 3, but with the absorbing layer 20 applied to a paper layer 44 which layer is translucent, allowing light to pass through, which paper may be made from wood pulp or maybe, synthetic, like that of a plastic paper or vellum. Applying a removable graphic element 46 which element may be a sketch printed on paper, able to be changed to reflect sketching techniques and levels of detail to promote artistic learning, thereafter, applying liquid 24 to the absorbing layer 20 which liquid may be of a blend of oil and water applied using a brush, applying the water, in doing so, temporarily revealing the underlying removable graphic element 46 which element may be a sketch, revealed sufficiently long enough to be able to draw over the sketch with a marking tool, which tool may be a pencil, a pen, charcoal, or any other type of marking tool, that may be used to temporarily reveal a graphic element 46 temporarily means that once revealed with water, the graphic element 46 after being revealed and sketched upon, will shortly after revert back to the original opacity of the absorbing layer 20 allowing the effects of the marking tool to remain clearly visible. Removable graphic element 46 means that the process and effects of the temporary reveal can be repeated, allowing different levels of sketching to be able to be achieved, thereby enabling different levels of artistic learning to be achieved.

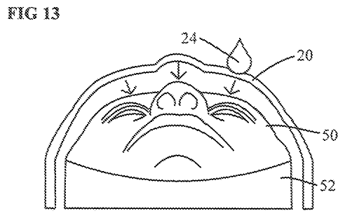

FIG. 13 is a cross section the same as FIG. 2, but with a solid 3D material surface 52 replacing the solid material surface 30 and a printed face model 52 replacing the visual elements 34 thereby changing the appreciation of the art from 2D to 3D while still maintaining the conventions. A solid 3D material surface 52 is fabricated, which surface may be made from either rigid or flexible material, produced on a 3D printer, from subject matter captured on a camera, thereafter translating the data into a 3D model, UV mapping the image data to the model, which data may be that of a face, which face for example may be that of a dolls face or the face of an action figure, then, either printing 3D CAD data in full color on a 3D printer, or unwrapping the data from the model and printing it on a mold-able film, before applying it with conformal accuracy to the 3D model as a skin, either method delivering the same result, a printed face model 50 affixed to a solid 3D material surface 52 with conformal accuracy, thereafter, applying the absorbing layer 20 to the printed face model 50 which application may use vacuum, heated assisted vacuum, or may use high velocity heated air, thereafter revealing the printed face model 50 with artistic endeavor, with liquid 24 which may be applied in the form of applying makeup, to reveal the underlying hidden face until it is clearly visible.

While the disclosed subject matter has been described in conjunction with a number of embodiments, it is evident that many alternatives, modifications and variations would be, or are, apparent to those of ordinary skill in the applicable arts. Accordingly, the applicant intends to embrace all such alternatives, modifications, equivalents and variations that are within the spirit and scope of the disclosed subject matter.

What is claimed is:

1. A medium comprising:
an opaque absorbing layer secured to a solid material carrier; and
a solid material carrier containing hidden visual elements under the absorbing material, which when liquid is applied are gradually revealed until said visual elements become clearly visible.

2. The medium of claim 1 further comprising a clear film secured between the absorbing layer and solid material carrier.

3. The medium of claim 2 further comprising an adhesive layer secured between the clear film and solid material carrier.

4. The medium of claim 3 further the visual elements comprise an ink layer secured between the clear film and adhesive layer.

5. The medium of claim 2 further wherein the absorbing layer further comprises printed areas designed to selectively block revealing of underlying visual elements.

6. The medium of claim 2 wherein the absorbing layer further comprises visual elements designed to make only selective areas of underlying visual elements clearly visible.

7. The medium of claim 2 further comprising an ink layer and marking materials between the clear film and the solid material carrier.

8. The medium of claim 1 wherein the visual elements are graphical.

9. The medium of claim 8 wherein the graphical visual elements are removable.

10. The medium of claim 9 further comprising a paper layer inserted between the absorbing layer and the removable graphical visual elements.

11. The medium of claim 1 wherein the solid material carrier is that of a texture.

12. The medium of claim 1 wherein the solid material carrier is three dimensional.

13. A method of making a material construction using a white opaque microporous liquid coating, coated to a releasable carrier, and thereafter transposed and heat laminated to a media as a non-transferable white opaque absorbing layer over hidden visual elements, which when liquid is applied, are gradually revealed until they are clearly visible.

14. The method of claim 12 wherein the white opaque absorbing layer is directly applied to a clear coating comprising visual elements.

15. The method of claim 12 wherein the white opaque absorbing layer is applied to a clear film, independent of a surface comprising visual elements.

16. The method of claim 12 wherein the white opaque absorbing layer is applied to a clear film, independent of a surface comprising visual elements, thereafter, being revealed and dried, to be completely scraped off using a scraping tool, used to further enhance the visual clarity of the surface comprising visual elements.

17. The method of claim 12 wherein the white opaque absorbing layer is applied to a clear film, independent of a surface comprising visual elements, thereafter, being revealed and dried, to be completely peeled off the film, used to further enhance the visual clarity of the surface comprising visual elements.

18. The method of claim 12 wherein the white opaque absorbing layer is applied to an optically clear film with adhesive coated on the underside, thereafter, being bonded to a surface comprising visual elements.

19. The method of claim 12 wherein the white opaque absorbing layer is applied to an optically clear film with visual elements printed on the underside, with an ink, thereafter, being able to be bonded to an adhesive bearing surface.

20. The method of claim 12 wherein the white opaque absorbing layer is enabled to be printed with an inkjet printer.

21. The method of claim 12 wherein the white opaque absorbing layer is enabled to receive visual elements, which surface can be enhanced with marking materials.
